(19) United States
(12) Patent Application Publication
(10) Pub. No.: US 2006/0176852 A1
(43) Pub. Date: Aug. 10, 2006

(54) System and method for connection handover in a virtual private network

(75) Inventors: Ko-Ching Wu, Taipei City (TW); Jen-Shun Yang, Hsinchu City (TW); Chen-Hau Lin, Taipei City (TW)

Correspondence Address: BIRCH STEWART KOLASCH & BIRCH, PO BOX 747, FALLS CHURCH, VA, 22040-0747, US

(73) Assignee: INDUSTRIAL TECHNOLOGY RESEARCH INSTITUTE

(21) Appl. No.: 11/221,790

(22) Filed: Sep. 9, 2005

(30) Foreign Application Priority Data
Feb. 4, 2005 (TW) 94103610

(51) Int. Cl. H04Q 7/00; H04L 12/56

(52) U.S. Cl. 370/331; 370/401

(57) ABSTRACT

A method and system of connection handover from a first wireless server to a second wireless server in a connection between a mobile device and an intranet. The method comprises employing a SIM-based pre-authentication with a mobile agent of the mobile device prior to handing over the connection to the second wireless server, and handing over the connection to the second wireless server upon a predetermined condition.

### BACKGROUND

The invention relates in general to connection handover, and in particular to a system and method of connection handover in a mobile VPN network.

Mobility has become an essential feature of telecommunication devices. As mobile devices gain momentum in the market, security issues has become as important as mobile convenience. An intuitive solution may be the combination of Mobile IP and IP Security (IPSec) protocols, or a combination of Virtual Private Network (VPN) and Mobile IP. Despite direct merging of two protocols reusing existent network hardware and software, reduced system efficiency is further caused by redundant elements shared by both protocols, such as VPN tunnel and Mobile IP tunnel.

A network domain isolated from other external networks (such as an Internet) is known as a Private Network, contacting external networks through a firewall for network security, as utilized typically for corporate networking, also known as Intranet. Anyone external to an external contact with the Intranet is through a lease line, or a dial up connection. The Private Network provides network security through physical network configuration.

Unfortunately, the remote access to a Private Network is not feasible for economic reasons. Due to the dispersive nature of energy on a transmission line, the cost of a lease line is proportional to the coverage range of data transmission. Similarly, the long distance costs grows with the calling rate.

Another approach focuses on VPN, where standard Internet for external connection with security is provided under a Private network. A Mobile Node carried by a user establishes a tunnel to a VPN gateway for the intranet, via an appropriate protocol such as PPTP, L2TP, or IPSec. The tunnel places the Mobile Node in a Private Network equivalent system, whereby security of the system is ensured. VPN tunnel is established across two VPN gateways, namely, a L2TP (Layer 2 Tunneling Protocol tunnel) Network Server (LNS) in a Private Network, and a L2TP Access Concentrator (LAC) in a remote network.

U.S. Pat. No. 6,496,491 B2 discloses a Mobile Point-to-Point Protocol providing a mobile connection, such that a mobile device may roam among LACs without interrupting the connection to the Intranet. However, the method does not support seamless connection handover, the authentication requiring input from a user. The invention is thus inappropriate for a real-time application.

### SUMMARY

According to embodiments of the invention, a method and system of a connection handover, from a first wireless server to a second wireless server in a connection between a mobile device and an intranet, is provided. The method comprises employing a SIM-based pre-authentication with a mobile agent of the mobile device prior to handing over the connection to the second wireless server, and handing over the connection to the second wireless server upon a predetermined condition.

The handover mechanism of the invention employs a SIM-based pre-authentication, performing SIM-based authentication for a mobile node, prior to handing over the telecommunication connection from a wireless server to neighboring wireless server. The SIM-based authentication is executed in VPN tunnels between Intranet and each foreign Intranet.

### BRIEF DESCRIPTION OF THE DRAWINGS

The invention will become more fully understood from the detailed description, given hereinbelow, and the accompanying drawings. The drawings and description are provided for purposes of illustration only and, thus, are not intended to limit the present invention.

FIG. 1 is a block diagram of a system for connection handover in a mobile VPN network, according to embodiments of the invention.

FIGS. 2A and 2B are flowcharts for a method of connection handover in a mobile VPN network, according to embodiments of the invention.

FIG. 3 is a block diagram of a wireless server connecting to a mobile node and a wireless Intranet, according to embodiments in the invention.

FIG. 4 is a block diagram of a mobile device connecting to a wireless Intranet through a first wireless server, according to embodiments in the invention.

### DETAILED DESCRIPTION

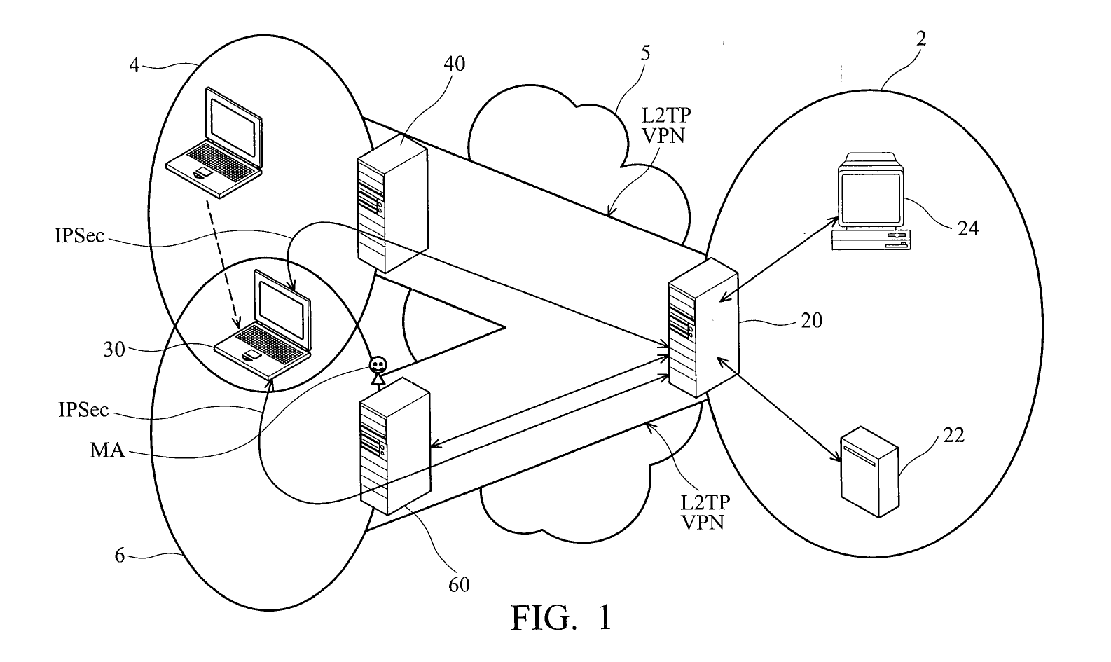

FIG. 1 is a block diagram of a system for connection handover in a mobile VPN network, according to embodiments in the invention, comprising a mobile node 30, a L2TP Network Server (LNS) 20, a first L2TP Access Contractor (LAC) 40, and a second LAC 60.

Mobile node 30 is a device capable of altering intermediate connecting points in a telecommunication connection, maintaining a fixed IP address while changing geometrical location, while maintaining communication via the intermediate connecting point in Internet 5 with a fixed IP. Mobile node 30 may be a notebook, a Personal Digital Assistant (PDA), a mobile phone, or any mobile device with equivalent functionality. LNS 20 acts as the only gateway in an Intranet 2, and controls access of all data traffic therethrough. LNS 20 establishes a connection with remote mobile node 30 through the first LAC 40 and the second LAC 60, governing respective network domains, also known as Foreign Intranet 4 and Foreign Intranet 6 correspondingly. Despite the absence of physical security configuration as intranet 2, a foreign intranet may achieve an equivalent security level through authentication and encryption. LNS 20 connects to LAC 40 and LAC 60 via fixed L2TP tunnels separately, resulting in a common network domain throughout Intranet 5, Foreign Intranet 4 and Foreign Intranet 6, such that Mobile Node 30 roams within the common network domain with no network domain switching. Intranet 5 comprises an Authentication Server 22, and an Application Server 24 as a Corresponding Node. Authentication Server 22 accepts an authentication request, and verifies and certifies authentication to Mobile Node 30. Application Server 24 then provides application service to the authenticated Mobile Node 30.

LACs permit unauthenticated Mobile Node 30 to connect to LNS 20 and Authentication Server 22, where Authentication Server 22 executes a SIM-based authentication through LNS 20. The SIM-based authentication is realized with extensible authentication protocol-subscriber identification module (EAP-SIM) authentication. Upon success of EAP-SIM authentication, Mobile Node 30 may enquire a service application from Corresponding Node 24. LNS 20 receives data packets for Mobile Node 30, encrypts the packets with IPSec protocol, and redirects the encrypted packets to LAC 40 or LAC 60, depending on the position of Mobile Node-30. Data packets for Application Server 24 are encrypted at Mobile Node 30, delivered to LNS 20 through the L2TP tunnel, decrypted with L2TP and IPSec protocols at LNS 20, and forwarded to Application Server 24.

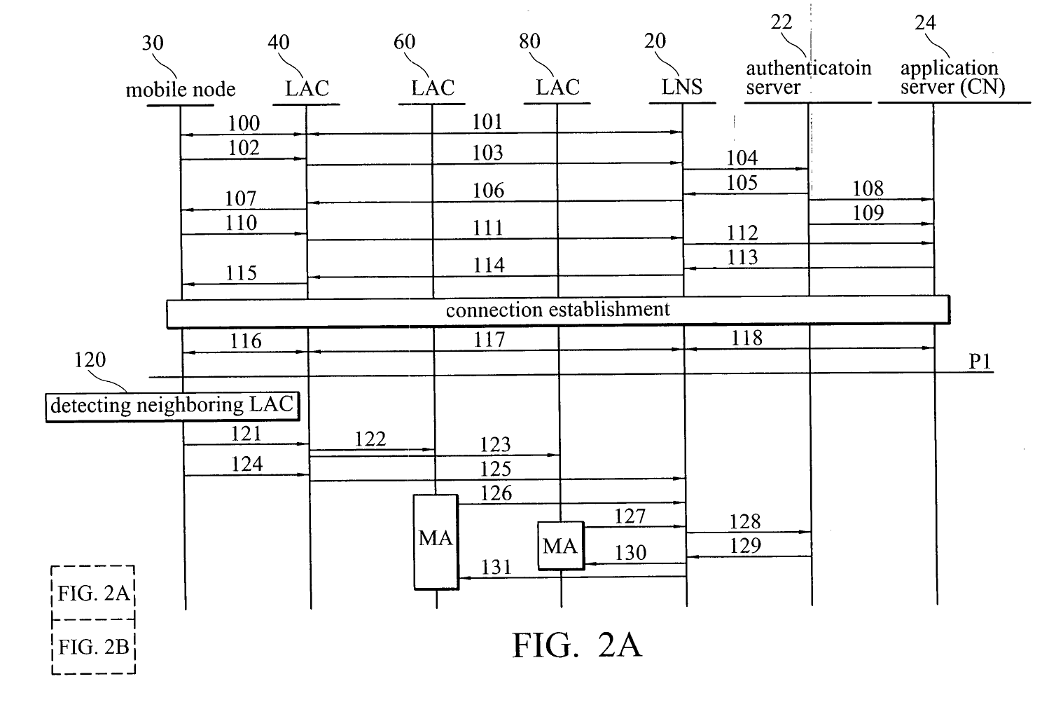

FIGS. 2A and 2B are flowcharts of a method of connection handover in a mobile VPN network, according to an embodiment in the invention, divided into three phases for clarity. In the first phase P1, a Mobile Node 30 establishes an IPSec tunnel to an LNS 20 through an LAC 40, executes an EAP-SIM authentication, and initiates data flow with an Application Server 24 for successful authentication. In the second phase P2, pre-authentication is carried out at a neighboring LAC 60 prior to a connection handover. Finally, the connection between Mobile Node 30 and LNS 20 is handed over from LAC 40 to LAC 60 in the third phase P3.

During the second phase P2, Mobile Node 30 may detect a decrease in signal strength from the access point (AP) in LAC 40, roaming in Foreign Intranet 1. When signal strength falls below a threshold level, Mobile Node 30 detects the existence of neighboring LACs, which may be realized via ESSID of neighboring access points.

Mobile Node 30 then duplicates and transmits a mobile agent (MA) to each of the detected LACs. The mobile agent acts as a representative of EAP-SIM authentication, and executes pre-authentication from the detected LACs, such that Mobile Node 30 may be transferred to the detected LAC immediately upon authentication being completed in advance. The mobile agent may be implemented as a software object, transferable to mobile agent platform in a system. In the embodiment, a Packet 121 carrying the duplicated mobile agent is initially delivered from Mobile Node 30 to LAC 40, which then forwards the mobile agent to detected LAC 60 and LAC 80 via Packet 122 and Packet 123 respectively. Each detected LAC receives a mobile agent, comprising a program to be executed on a mobile agent platform respectively.

As Mobile Node 30 distributes the mobile agent, it also provides the number of duplicated mobile agents to LNS 20 via Packet 124. When each mobile agent arrives at LAC 40 and LAC 80, an authentication request Packet 126 or 127 is issued correspondingly. Upon receiving the first authentication request packet, LNS 20 redirects an authentication request Packet 128 to Authentication Server 22, and puts the subsequent authentication request packets on hold, so that repeated authentication in a short time is prevented. LNS 20 then forwards response from Authentication Server 22 to the mobile agents transmitting the same request packet, where the number of the mobile agents is informed beforehand.

Authentication Server 22 executes a SIM-based authentication according to the authentication request packets, and responds with an authentication response Packet 129 to LNS 20, which keeps a record of the authentication status for all mobile agents. If authentication response Packet 129 contains authentication rejection information, LNS20 terminates data transmission to LAC 60 and LAC 80. If authentication response Packet 129 contains authentication acceptance information, subsequent procedures are carried out.

Apart from acting as a gateway in Intranet 2, LNS 20 also possesses partial functionality of a home agent (HA), receiving and redirecting packets for Mobile Node 30. The Home Agent contains a binding list recording the present address of Mobile Node 30, known as Care of Address (CoA), indicating the redirection destination of data packets for Mobile Node 30. Care of address is here the address of LAC with an authenticated mobile agent. Consequently the home agent directs data packets to authenticated LAC, which in turn transmits data packets to corresponding Mobile Node 30. Authenticated LAC 60 and LAC 80 are added to the linking list since Mobile Node 30 may move under their transmission coverage.

LNS 20 performs multicast procedure 133, transmits data packets to Mobile Node 30, and the mobile agents in LAC 60 and LAC 80, receives data packets from the LACs in the linking list, as shown by data transmission Packet 136 and 137 respectively. Consequently the data transmission remains continuous when Mobile Node 30 switches to a neighboring LAC, eliminating delays from data redirection. In view of Layer 2 protocol, the data transmission is multicast with separate sets of layer 2 address for each LAC, in view of Layer 3, it is an identical transmission with the same IP addresses for each LAC.

Upon receiving the response of Authentication Server 22, LNS 20 updates the linking list for multicast. LAC acts as a conditional firewall, allowing Mobile Node 30 to communicate with Corresponding Node 24 if LAC receives an authentication acceptance packet. Each LAC keeps a list of authenticated mobile nodes, since utilization right of a VPN tunnel is under surveillance for bandwidth allocation.

In the third phase P3, if the signal strength from the access point of LAC 40 falls below a threshold value, and a stronger signal from the access points of LAC 60 or LAC 80 is detected, a layer two handover procedure 140 is executed, comprising switching to the other access point for data reception. Upon completion of layer two handover, Mobile Node 30 resumes data transmission in the local network immediately. Because the IP address of Mobile Node 30 remains unchanged, it is not necessary to perform a layer three handover, or request a new IP address.

Next, Mobile Node 30 makes contact with the mobile agent, accepts an authentication report 147, comprising the authentication result and other information, via IPSec authentication. The data transmission between Mobile Node 30 and LNS 20 is secured by IPSec protocol. As the IP address of both Mobile node and LNS 20 may remain unchanged, IPSec re-establishment may be obviated. If the authentication result in the report 147 is authentication acceptance, Mobile Node 30 carries out data transmission with Corresponding Node 24. If authentication result is authentication rejection, the connection to Corresponding Node 24 is interrupted, and Mobile Node 30 enters an exit handover procedure.

Mobile Node 30 issues a location update Packet 148 to LNS 20, such that the linking list at LNS 20 is updated with active LAC 60. Concurrently LNS 20 delivers Packets 150 and 151 to inform LAC 40 and LAC 80 that a new address has been allocated to Mobile Node 30, and the mobile agent in the respective LAC may be released. Since only the address of LAC 60 remains in the linking list, LNS 20 directs data packets to Mobile Node 30 via uni-cast.

The SIM-based pre-authentication provides a mechanism requiring no human interaction, such that handover delay is kept under control. Furthermore, the pre-authentication speeds the handover process, such that the mobile node does not have to wait to be authenticated. A VPN tunnel joins an Intranet and individual foreign Intranet to form a single private network. Since the mobile node roams within a single private network, data packets to the mobile node may employ an identical Layer Three IP address, eliminating delay for allocation thereof.

Accordingly, data disconnection only requires around 100 ms, accounted for Layer Two handover of the connection. Data flow remains continuous except for the data disconnection period, resulting in a seamless connection handover. If multicast functionality is removed in the consideration of bandwidth or device efficiency, the data disconnection period merely requires another 140 ms, accounting for updating the linking list in the home agent and propagation delay between the LNS and the mobile node. The seamless connection handover in the invention thus supports real time application.

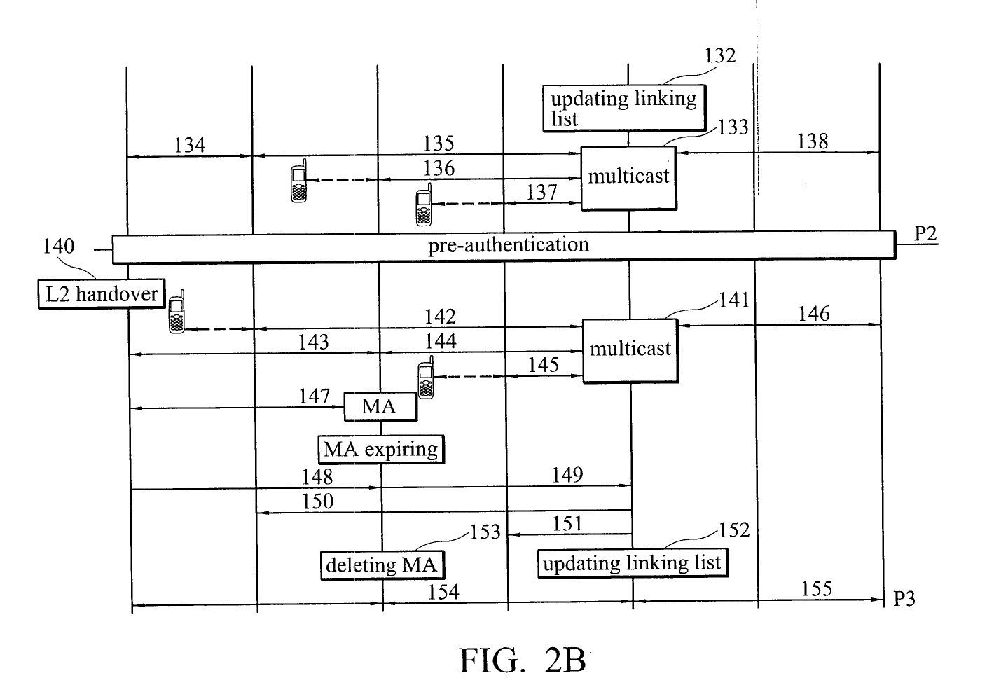

FIG. 3 is a block diagram of a wireless server 30 connecting a mobile node and a wireless Intranet, according to an embodiment of the invention. Wireless server 30 comprises a processor 300, a port 302, and program storage media 304. Port 302 and program storage media 304 are coupled to the processor 300. Program storage media 304 comprises a program adapted to a first code, employing an SIM-based pre-authentication via a mobile agent of the mobile device prior to handing over the connection to the wireless server, and a second code, taking over connection from a first wireless server if the mobile node receives signal strength from a remote wireless server being less than a first predetermined value, and signal strength from the wireless server 30 exceeds a second predetermined value.

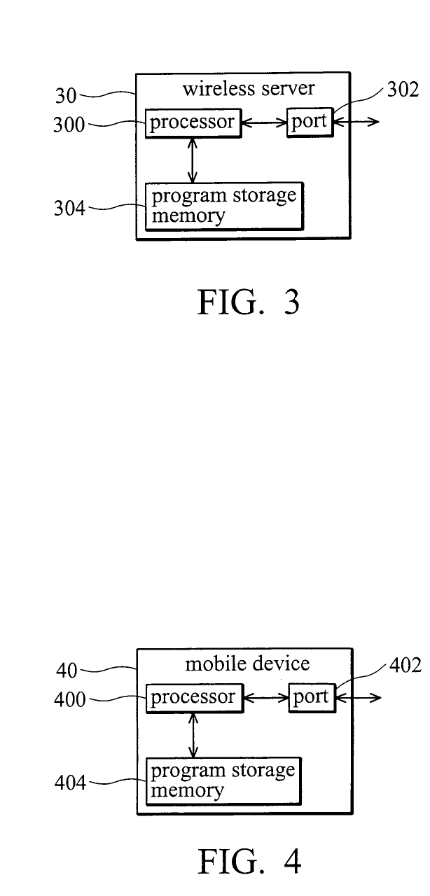

FIG. 4 is a block diagram of a mobile device 40 connecting to a wireless Intranet through a first wireless server, according to an embodiment of the invention. Mobile device 40 comprises a processor 400, a port 402, and a program storage media 404. Port 402 and program storage media 404 are coupled to the processor 400. Program storage media 404 comprises program adapted to first code, employing an SIM-based pre-authentication with a mobile agent of the mobile device prior to handing over the connection to a second wireless server among a neighboring wireless server, and second code, handing over the connection to the second wireless server if signal strength from the first wireless server is less than a first predetermined value, and signal strength from the second server exceeds a second predetermined value.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of handover from a first wireless server to a second wireless server among neighboring wireless servers in a connection between a mobile device and a border gateway of an intranet, comprising:
employing a SIM-based pre-authentication with a mobile agent of the mobile device prior to handing over the connection to the second wireless server; and
handing over the connection to the second wireless server upon a predetermined condition.

2. The method of claim 1, wherein the employing step comprises:
providing number of the neighboring wireless server to the border gateway;
sending the mobile agent to the neighboring wireless server; and
processing SIM-based authentication via the mobile agent.

3. The method of claim 2, further comprising:
updating SIM-based authenticated wireless server to a binding list at the border gateway; and
directing downlink data to the wireless servers based on the binding list.

4. The method of claim 1, wherein the predetermined condition is signal strength from the first wireless server being less than a first predetermined value, and signal strength from the second wireless server exceeding a second predetermined value.

5. The method of claim 2, further comprising:
receiving an authentication result of the second wireless server at the mobile device from the mobile agent;
stopping the connection if the authentication result is authentication rejection; and
updating the second wireless server to the binding list if the authentication result is authentication acceptance.

6. The method of claim 1, further comprising:
establishing a Virtual Private Network (VPN) tunnel between the second wireless server and the border gateway; and
transferring data with identical mobile device address throughout the connection via the VPN tunnel.

7. A wireless server in a connection of a mobile device and a border gateway of an intranet, comprising:
a processor;
a port, coupled with the processor; and
program storage memory coupled with the processor, comprising program adapted to:
first code, employing an SIM-based pre-authentication with a mobile agent of the mobile device prior to handing over the connection to the wireless server; and
second code, taking over the connection from a first wireless server upon a predetermined condition.

8. The wireless server of claim 7, wherein the first code comprises:
accepting the mobile agent at the wireless server; and
processing SIM-based authentication via the mobile agent.

9. The wireless server of claim 8, wherein the first code further comprises receiving data at the wireless server based on a binding list storing information of SIM-based authenticated wireless server.

10. The wireless server of claim 8, wherein the program further comprises third code, transmitting an authentication report from the mobile agent to the mobile device.

11. The wireless server of claim 7, wherein the predetermined condition comprises the mobile device receiving signal strength from a remote wireless server being less than a first predetermined value and receiving signal strength from the wireless server exceeding a second predetermined value.

12. The wireless server of claim 7, wherein the program is further adapted to a fourth code:
establishing a VPN tunnel between the wireless server and the border gateway; and
transferring data with an identical mobile device address throughout the connection via the VPN tunnel.

13. A mobile device having a connection with a border gateway of an intranet via a first wireless server, comprising:
a processor;
a port, coupled with the processor and the border gateway; and
program storage memory coupled with the processor, comprising program adapted to:
first code, employing an SIM-based pre-authentication with a mobile agent of the mobile device prior to handing over the connection to a second wireless server among a neighboring wireless server; and
second code, handing over the connection to the second wireless server upon a predetermined condition.

14. The mobile device of claim 13, wherein the first code comprising:
providing number of the neighboring wireless server to the border gateway;
transferring the mobile agent to the neighboring wireless server; and
processing SIM-based authentication via the mobile agent.

15. The mobile device of claim 14, wherein the first code further comprises receiving downlink data at the mobile device based on a binding list storing information of SIM-based authenticated wireless servers.

16. The mobile device of claim 13, wherein the program further comprises third code:
receiving an authentication report from the mobile agent at the mobile device;
stopping the connection if the authentication report is rejected; and
updating the second wireless server to the binding list at the border gateway if the authentication report is accepted.

17. The mobile device of claim 13, wherein the predetermined condition comprises signal strength from the first wireless server being less than a first predetermined value and signal strength from the second wireless server exceeding a second predetermined value.

18. The mobile device of claim 13, wherein the program further comprises fourth code, transferring data with an identical mobile device address throughout the connection via the VPN tunnel established between the second wireless server and the border gateway.

19. A system comprising:
a mobile device, participating in a connection;
an intranet, coupled to the mobile device during the connection;
a first wireless server, coupled to the mobile device and a border gateway of the intranet prior to connection handover; and
a second wireless server, coupled to the mobile device and the border gateway upon the connection handover, employing an SIM-based pre-authentication with a mobile agent of the mobile device prior to taking over the connection upon a predetermined condition.

20. The system of claim 19, wherein the SIM-based pre-authentication comprises:
detecting the second wireless server among at least one neighboring wireless server neighboring the first wireless server;
providing number of the at least one neighboring wireless server to the border gateway;
sending the mobile agent to the second wireless server; and
processing SIM-based authentication via the mobile agent.

21. The system of claim 20, wherein the SIM-based pre-authentication further comprises:
updating the SIM-based authenticated wireless server to a binding list at the border gateway; and
directing downlink data to wireless servers based on the binding list.

22. The system of claim 20, wherein the second wireless server further comprises transferring an authentication report from the mobile agent to the mobile device.

23. The system of claim 19, wherein the predetermined condition comprises signal strength from the first wireless server being less than a first predetermined value, and signal strength from the second wireless server exceeding a second predetermined value.

24. The system of claim 19, wherein the second wireless server further comprises:
establishing a VPN tunnel between the second wireless server and the intranet; and
transferring data with an identical mobile device address throughout the connection via the VPN tunnel.
